(19) United States
(12) Patent Application Publication
(10) Pub. No.: US 2006/0013202 A1
(43) Pub. Date: Jan. 19, 2006

(54) Content reproducing device, server and content distribution system

(75) Inventor: Tsuneyuki Koikeda, Hamamatsu-shi (JP)

Correspondence Address: PILLSBURY WINTHROP SHAW PITTMAN LLP, 725 S. FIGUEROA STREET, SUITE 2800, LOS ANGELES, CA, 90017, US

(73) Assignee: Yamaha Corporation, Hamamatsu-shi (JP)

(21) Appl. No.: 11/181,557

(22) Filed: Jul. 14, 2005

(30) Foreign Application Priority Data
Jul. 16, 2004 (JP) 2004-210710

(51) Int. Cl. H04L 12/54; H04L 12/66

(52) U.S. Cl. 370/352

(57) ABSTRACT

A content reproducing device includes an IP telephone unit that conducts IP telephone communications using a predetermined protocol, an internet communication unit that communicates with a content server storing content data through the Internet, a content reproducing unit that reproduces the content data, and an authentication request unit that requests the server to authenticate a downloading of the content data through the IP telephone unit when the internet communication unit transmits a request for downloading the content data from the content server. The internet communication unit receives the content data downloaded from the content server. The content reproducing unit reproduces the downloaded content data.

### BACKGROUND OF THE INVENTION

This invention relates to an art of distributing content through a communication network.

Various arts are developed for content distribution and charging using the Internet. For example, JP-A-2003-178239 describes the following content distribution and charging processes.

When a user terminal accesses a distribution control server of a moving image content provider through the Internet, the telephone number of the moving image content provider and a moving image content recognition password are returned to the user terminal. When the user calls the provider at the telephone number from a telephone, the user is connected to a pay dial charging system and is connected through the pay dial charging system to a voice response authentication server of the moving image content provider. The voice response authentication server requests the user to send the moving image content recognition password. The user transmits the moving image content recognition password as a pushbutton signal of the telephone in response to the request. If the voice response authentication server recognizes that the received moving image content recognition password is valid, the voice response authentication server permits the distribution control server to distribute moving image content. Accordingly, the user can view the moving image content.

However, in the related art described above, the user must have two communication channels of the terminal for using content and the telephone for authentication and charging and thus the operation is intricate.

### SUMMARY OF THE INVENTION

It is therefore an object of the invention to provide a content reproducing device and a content distribution system capable of conducting authentication and supplying content according to a simple configuration and by easy operation.

In order to achieve the above object, according to the present invention, there is provided a content reproducing device, comprising:
an IP telephone unit that conducts IP telephone communications by using a predetermined protocol;
an internet communication unit that communicates with a content server storing content data through the Internet;
a content reproducing unit that reproduces the content data; and
an authentication request unit that requests the server to authenticate a downloading of the content data through the IP telephone unit when the internet communication unit transmits a request for downloading the content data from the content server,
wherein the internet communication unit receives the content data downloaded from the content server; and
wherein the content reproducing unit reproduces the downloaded content data.

According to the invention, when a request for downloading content is made, communications with a predetermined server are conducted by using IP telephone unit, the predetermined server is requested to authenticate the downloading, and the content data is downloaded.

Preferably, the IP telephone unit is an SIP communication unit for conducting communications in accordance with Session Initiation Protocol.

According to the invention, when a request for downloading content is made, communications with a predetermined server are conducted in accordance with SIP, the predetermined server is requested to authenticate the downloading, and the content is downloaded.

Here, it is preferable that, a content distribution system, comprising:
a content reproducing device;
a server; and
a content server that is configured to store content data,
wherein the content reproducing device, includes:
   an IP telephone unit that conducts IP telephone communications by using a predetermined protocol;
   an internet communication unit that communicates with a content server through the Internet;
   a content reproducing unit that reproduces the content data; and
   an authentication request unit that requests the server to authenticate a downloading of the content data through the IP telephone unit when the internet communication unit transmits to the content server a request for downloading the content data from the content server;
wherein the server includes:
   an authentication determination unit that determinates whether the downloading is authenticated when the request for authenticating the downloading is received from the content reproducing device; and
   an output unit that outputs an authentication result of the authentication determination unit to the content server; and
wherein the content server includes a downloading permission unit that determines whether the downloading is permitted in accordance with the authentication result outputted from the server.

According to the invention, when the content reproducing device makes a request for downloading content data, communications are conducted between the content reproducing device and a predetermined server by using IP telephone, and the predetermined server is requested to authenticate the downloading. The server determines whether or not the downloading is authenticated, and outputs the authentication result to the content server, which then determines whether or not the downloading is permitted in response to the authentication result outputted from the server.

Preferably, the IP telephone unit is an SIP communication unit for conducting communications in accordance with Session Initiation Protocol.

According to the invention, when the content reproducing device makes a request for downloading content data, communications are conducted between the content reproducing device and a predetermined server in accordance with SIP, and the predetermined server is requested to authenticate the downloading. The server determines whether or not the downloading is authenticated, and outputs the authentication result to the content server, which then determines whether or not the downloading is permitted in response to the authentication result supplied from the server.

Here, it is preferable that, a server, comprising:
a receiving unit that receives a request for authenticating a downloading of content data stored in a content server through an IP telephone communications from a content reproducing device;
an authentication determination unit that determinates whether the downloading of the content data to the content server is authenticated when the request is received; and
an output unit that outputs an authentication result of the authentication determination unit to the content server.

Preferably, the server is an IP telephone server.

Preferably, the content data is musical performance data indicating musical performance of a musical sound. The content reproducing unit is an electronic musical instrument for performing automatic playing based on the musical performance data.

Preferably, the content data is audio data. The content reproducing unit is a reproducing apparatus for reproducing the audio data.

Preferably, the content data downloaded from the content server includes identification data for identifying a content reproducing device that requests the server to authenticate the downloading of the content data. The content reproducing unit reproduces the downloaded content data when the content reproducing device that receives the content data from the content server matches with the content reproducing device identified by the identification data.

Preferably, the server is configured to connect to a plurality of the content servers. The receiving unit receives the request for authenticating the downloading of content data stored in at least one of the content servers.

Preferably, the server includes an IP telephone unit that conducts IP telephone communications with the reproducing device by using a predetermined protocol in accordance with identification data for identifying the reproducing device.

According to the invention, it is possible to conduct authentication and supply content according to a simple configuration and by easy operation.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a diagram to show the general configuration of a content distribution system according to a first embodiment of the invention;

FIG. 2 is a drawing to show the format of a charging table TBL1 according to the embodiment of the invention;

FIG. 3 is a drawing to show the format of an authentication table TBL2 according to the embodiment of the invention;

FIG. 4 is a block diagram to show the configuration of an electronic musical instrument 10 according to the embodiment of the invention;

FIG. 5 is a flow chart to describe the operation of the content distribution system according to the embodiment of the invention;

FIG. 6 is a drawing to show a Web page displayed on the electronic musical instrument; and

FIG. 7 is a drawing to show a Web page displayed on the electronic musical instrument.

### DETAILED DESCRIPTION OF THE PREFERRED EMBODIMENTS

FIG. 1 is a diagram to show the general configuration of a content distribution system according to a first embodiment of the invention. As shown in FIG. 1, an electronic musical instrument 10, an authentication server 20, and a content server 30 are connected to Internet 40.

The content server 30 includes a control section configured by a CPU (Central Processing Unit), ROM (Read-Only Memory), RAM (Random Access Memory), etc., a storage section from and into which various pieces of data can be read and written, a communication interface for conducting communications through the Internet 40, a display section including a liquid crystal display, etc., and an operation section including a keyboard, a mouse, etc.

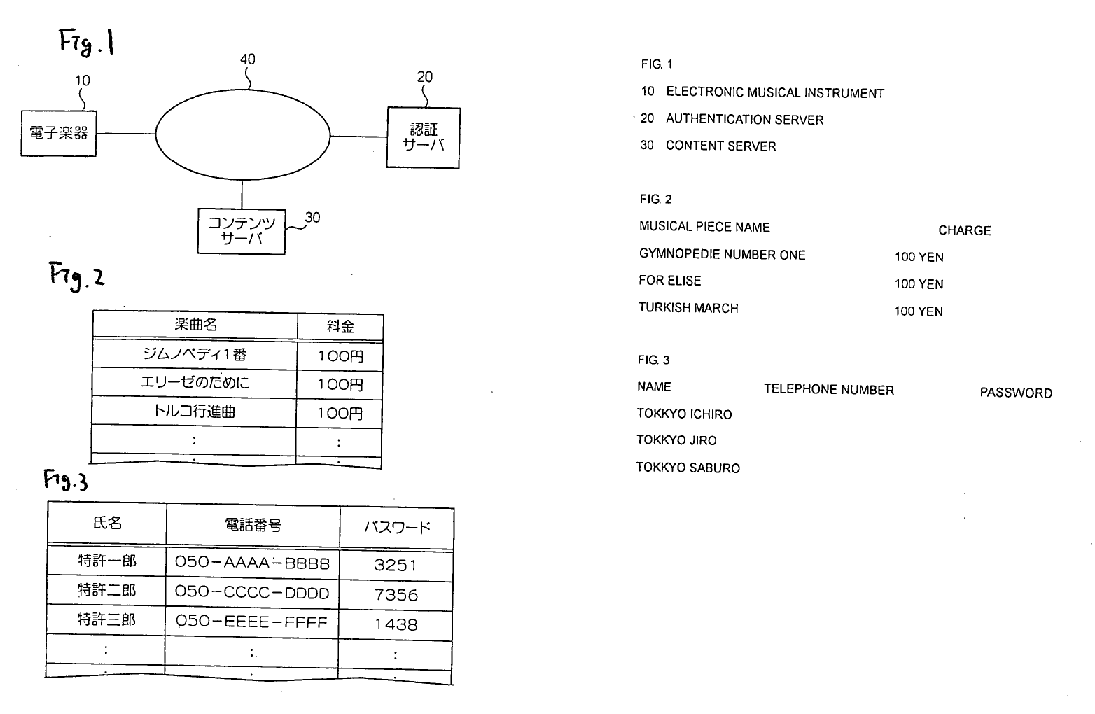

The storage section stores various pieces of content data such as musical performance data, a distribution control program, data representing various Web pages, a charging table TBL1, etc. FIG. 2 is a drawing to illustrate the format of the charging table TBL1. As shown in FIG. 2, the table stores the use charge of musical performance data for each piece of musical performance data. The control section distributes musical performance data through the Internet 40 in response to a request from an apparatus serving as a client based on the distribution control program stored in the storage section.

The authentication server 20 is server for determining whether or not content distribution from the content server 30 to the electronic musical instrument 10 is permitted. Like the content server 30, the authentication server 20 includes a control section, a storage section, a communication interface, a display section, and an operation section. The storage section stores an authentication program, an authentication table TBL2, etc. FIG. 3 is a drawing to illustrate the format of the authentication table TBL2. As shown in FIG. 3, the table stores the name of each person permitted to acquire musical performance data from the content server 30 and the telephone number and the password given to the person permitted to acquire the musical performance data in association with each other. The control section of the authentication server 20 determines whether or not content distribution from the content server 30 to the electronic musical instrument 10 is permitted based on the authentication program stored in the storage section. The control section also charges the user for use of the musical performance data distributed from the content server 30 based on the authentication program. The control section also conducts communications with any other apparatus using Internet telephone service in accordance with SIP (Session Initiation Protocol) or VoIP (Voice over Internet Protocol) based on the authentication program.

The electronic musical instrument 10 is, for example, an electronic piano, and outputs a musical sound in response to the pressed key. As shown in FIG. 4, the electronic musical instrument 10 has sections connected to a bus 101 through which a signal is transferred from one section to another. An operation section 106 includes various keys to operate the electronic musical instrument 10, such as arrow keys and a numeric keypad. A communication section 107 includes a function as a communication interface and is connected to the Internet 40. The communication section 107 supplies a signal sent from the Internet 40 to a CPU 102 and also outputs a signal output from the CPU 102 to the Internet 40. A display section 108 includes a display such as a liquid crystal display and displays various menu screens, musical scores, etc., under the control of the CPU 102. A keyboard section 109 includes a number of keys. When a player presses a key, the keyboard section 109 outputs a signal indicting the pressed key. A musical sound generation section 110 generates a musical sound signal in response to the signal output from the keyboard section 109 and produces a musical sound responsive to the musical sound signal from a speaker (not shown). The musical sound generation section 110 also generates a musical sound signal in accordance with musical performance data supplied via the bus 101 and produces a musical sound responsive to the musical sound signal from the speaker for performing automatic playing. A storage section 105 includes storage of an HDD, etc., for storing various pieces of data. The storage section 105 stores the telephone number given to the user of the electronic musical instrument 10, the password used for acquiring musical performance data, the telephone number given to the authentication server 20, the URL (Uniform Resource Locator) of a Web page stored in the content server 30, etc., as the various pieces of data. The storage section 105 also stores the musical performance data acquired from the content server 30. The stored musical performance data cannot be taken out from the electronic musical instrument 10 to the outside.

ROM 103 stores a control program for controlling the sections of the electronic musical instrument 10. Based on the control program, the CPU 102 communicates with an apparatus connected to the Internet 40 in accordance with a protocol such as HTTP (HyperText Transfer Protocol), for example, and acquires various pieces of data such as data representing Web pages and musical performance data. The CPU 102 also plays back the acquired data based on the control program. The CPU 102 also communicates with another apparatus using Internet telephone service in accordance with SIP or VoIP based on the control program.

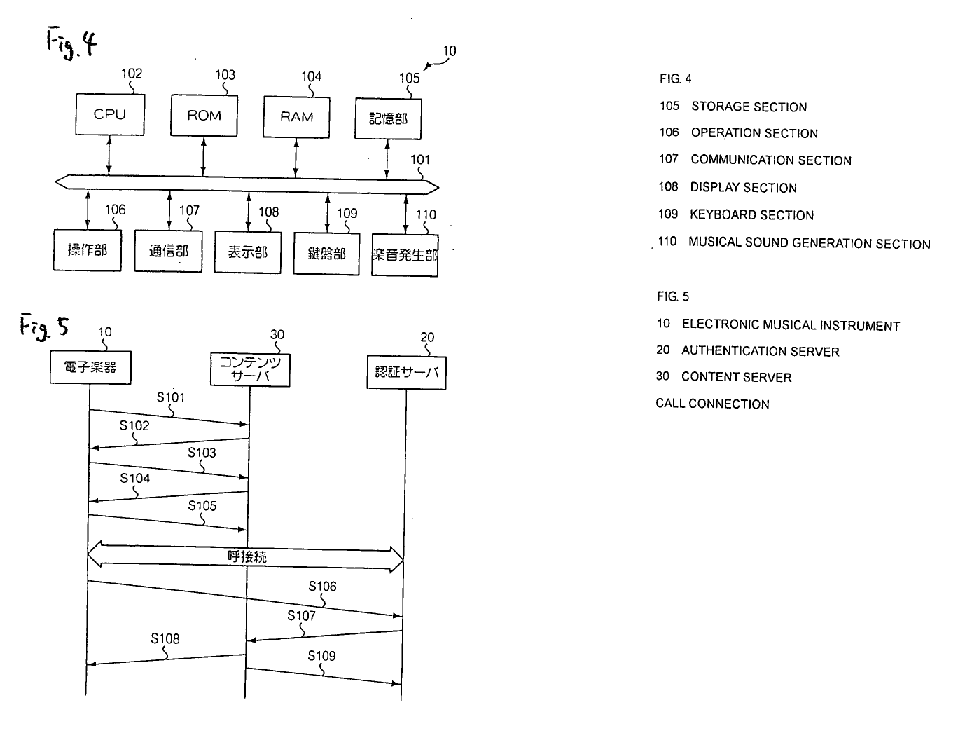

Next, the operation of the content distribution system of the embodiment will be discussed with FIG. 5.

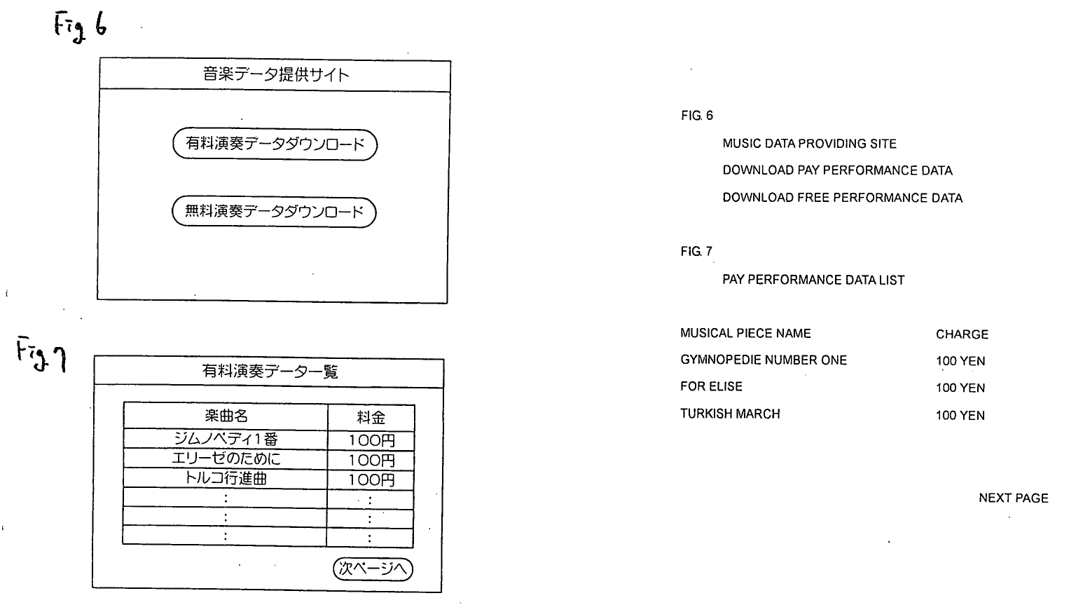

When the user of the electronic musical instrument 10 operates the operation section 106 to enter a command for connecting to the content server 30, the CPU 102 reads the URL previously stored in the storage section 105. Next, the CPU 102 communicates with the content server 30 in accordance with the HTTP (step S101 in FIG. 5), acquires the data identified by the URL from the content server 30 (step S102), and displays a Web page on the display section 108 as illustrated in FIG. 6 in accordance with the acquired data. When the user sees a menu screen illustrated in FIG. 6 and clicks on a button of DOWNLOAD PAY PERFORMANCE DATA in the menu screen, the CPU 102 communicates with the content server 30 (step S103) and acquires the Web page linked with the button (step S104). When the CPU 102 acquires the Web page, a page listing the musical performance data stored by the content server 30 is displayed as illustrated in FIG. 7. Next, when the user sees the screen and clicks on the musical piece name of any desired musical piece, the CPU 102 generates a download request message containing the clicked musical piece name and the telephone number of the user stored in the storage section 105 and transmits the message to the content server 30 (step S105). Next, the CPU 102 reads the telephone number given to the authentication server 20 from the storage section 105 and uses the Internet telephone service to attempt to make call connection with the authentication server 20.

When call connection is made between the electronic musical instrument 10 and the authentication server 20, the CPU 102 reads the telephone number of the user and the password stored in the storage section 105 and transmits them to the authentication server 20 (step S106). Upon reception of the telephone number and the password, the authentication server 20 searches the telephone number storage field of the authentication table TBL2 for the received telephone number used as a search key. When the authentication server 20 finds the telephone number used as the search key, the authentication server 20 determines whether or not the password stored in association with the telephone number and the received password are the same. If the passwords match, the authentication server 20 determines that the user of the electronic musical instrument 10 is permitted to acquire the musical performance data. If the authentication server 20 determines that the user of the electronic musical instrument 10 is permitted to acquire the musical performance data, the authentication server 20 generates a download permission message containing the received telephone number and transmits the message to the content server 30 (step S107). If the received telephone number is not stored in the authentication table TBL2 or if the passwords do not match, the authentication server 20 determines that the user of the electronic musical instrument 10 is not permitted to acquire the musical performance data, and transmits a download non-permission message containing the received telephone number to the content server 30.

Upon reception of the download request message transmitted from the electronic musical instrument 10 at step S105, first the content server 30 stores the musical piece name and the telephone number contained in the received message in the RAM 104 in association with each other, and waits for a message transmitted from the authentication server 20. If the content server 30 receives the download non-permission message transmitted from the authentication server 20, extracts the telephone number contained in the message, and does not permit distribution of the musical performance data to the electronic musical instrument 10 transmitting the telephone number. Upon reception of the download permission message, the content server 30 extracts the telephone number contained in the message. If the extracted telephone number is stored in the RAM 104, the content server 30 reads the musical piece name stored in association with the telephone number. The content server 30 reads the musical performance data identified by the read musical piece name from the storage section and transmits the read musical performance data to the electronic musical instrument 10 (step S108). The content server 30 uses the charging table TBL1 to determine the charge for the musical performance data identified by the musical piece name, and transmits a charging message containing the charge data indicating the charge and the telephone number extracted from the download permission message to the authentication server 20 (step S109).

Upon reception of the charging message, the authentication server 20 extracts the telephone number and the charge data, and searches the telephone number field of the authentication table TBL2 for the telephone number used as a search key. If the authentication server 20 finds the telephone number used as the search key, the authentication server 20 stores the amount indicating the charge data in association with the name stored in association with the telephone number. The authentication server 20 will later perform processing of taking out the stored amount from the bank account.

Upon reception of the musical performance data transmitted from the content server 30, the CPU 102 of the electronic musical instrument 10 supplies the received musical performance data to the musical sound generation section 110. The musical sound generation section 110 generates a musical sound signal in accordance with the supplied musical performance data and produces a musical sound responsive to the musical sound signal from the speaker for performing automatic playing.

As described above, the embodiment enables the person who attempts to acquire musical performance data to acquire musical performance data without having the two communication channels of a musical performance data reproducing device and a terminal for authentication and charging.

The musical performance data is downloaded directly into the electronic musical instrument 10 not via a personal computer, etc., and cannot be taken out from the electronic musical instrument 10 to the outside, so that illegal copying can be prevented.

Although the invention has been described based on the embodiment, it is to be understood that the invention is not limited to the specific embodiment described above and can be embodied in other various forms. For example, the embodiment described above may be modified to embody the invention as follows:

The electronic musical instrument 10 is not limited to an electronic piano and may be any other electronic musical instrument. The component that can acquire musical performance data from the content server 30 is not limited to the electronic musical instrument 10. An audio apparatus or a television receiver may be provided with a communicating function through the Internet and may be caused to communicate with the content server 30 and the authentication server 20 like the electronic musical instrument 10 described above. To distribute content to such an AV machine, for example, audio data such as MP3 (MPEG Audio Layer-3) may be distributed and be played back by the AV machine.

In the embodiment described above, the authentication server 20 may be a charging server (IP telephone server) for charging for use of IP telephone in a communication network for providing Internet telephone service. The charge for musical performance data may be collected together with the charge for the IP telephone.

A plurality of content servers 30 may be connected to the Internet 40 and content distribution authentication may be conducted in one authentication server 20. According to the modification, it is not necessary to provide authentication unit for each content server, so that it is made possible to simplify the configuration of the content server.

The content server 30 may embed the telephone number transmitted from the electronic musical instrument 10 in musical performance data when transmitting the musical performance data. The electronic musical instrument 10 may be enabled to reproduce the musical performance data only if the telephone number embedded in the musical performance data and the telephone number stored in the storage section match. According to the modification, it is made impossible to reproduce the musical performance data in any other than the electronic musical instrument into which the musical performance data is downloaded.

The method of determining whether or not the person is permitted to receive distribution of musical performance data is not limited to the method of the embodiment described above and various modifications can be made. For example, the following determination may be made:

The content server 30 transmits the received telephone number and the charge data for the musical performance data to the authentication server 20. The authentication server 20 makes a call connection with the electronic musical instrument 10 identified by the received telephone number, receives the password from the electronic musical instrument 10, and determines whether or not the user of the electronic musical instrument 10 is permitted to receive distribution of the musical performance data. To permit transmission of the musical performance data, the authentication server 20 stores the amount indicated by the charge data and also transmits the determination result to the content server 30.

In the modification, the authentication server 20 may wait for a call connection request to come from the electronic musical instrument 10 rather than make call connection to the electronic musical instrument 10 on its own initiative and if the telephone number matching the telephone number transmitted from the content server 30 is transmitted from the electronic musical instrument 10, the authentication server 20 may determine whether or not the user of the electronic musical instrument 10 is permitted to receive distribution of the musical performance data in a similar manner to that in the embodiment described above.

In the embodiment described above, the authentication server 20 may be an SIP server to realize communications conforming to SIP in a communication network, namely, may be a server provided by integrating a proxy server, a redirect server, and a register server.

Although the invention has been illustrated and described for the particular preferred embodiments, it is apparent to a person skilled in the art that various changes and modifications can be made on the basis of the teachings of the invention. It is apparent that such changes and modifications are within the spirit, scope, and intention of the invention as defined by the appended claims.

The present application is based on Japan Patent Application No. 2004-210710 filed on Jul. 16, 2004, the contents of which are incorporated herein for reference.

What is claimed is:

1. A content reproducing device, comprising:
an IP telephone unit that conducts IP telephone communications by using a predetermined protocol;
an internet communication unit that communicates with a content server storing content data through the Internet;
a content reproducing unit that reproduces the content data; and
an authentication request unit that requests the server to authenticate a downloading of the content data through the IP telephone unit when the internet communication unit transmits a request for downloading the content data from the content server,
wherein the internet communication unit receives the content data downloaded from the content server; and
wherein the content reproducing unit reproduces the downloaded content data.

2. The content reproducing device as set forth in claim 1, wherein the IP telephone unit is an SIP communication unit for conducting communications in accordance with Session Initiation Protocol.

3. The content reproducing device as set forth in claim 1, wherein the server is an IP telephone server.

4. The content reproducing device as set forth in claim 1, wherein the content data is musical performance data indicating musical performance of a musical sound; and
wherein the content reproducing unit is an electronic musical instrument for performing automatic playing based on the musical performance data.

5. The content reproducing device as set forth in claim 1, wherein the content data is audio data; and
wherein the content reproducing unit is a reproducing apparatus for reproducing the audio data.

6. The content reproducing device as set forth in claim 1, wherein the content data downloaded from the content server includes identification data for identifying a content reproducing device that requests the server to authenticate the downloading of the content data; and
wherein the content reproducing unit reproduces the downloaded content data when the content reproducing device that receives the content data from the content server matches with the content reproducing device identified by the identification data.

7. A content distribution system, comprising:
a content reproducing device;
a server; and
a content server that is configured to store content data,
wherein the content reproducing device, includes:
an IP telephone unit that conducts IP telephone communications by using a predetermined protocol;
an internet communication unit that communicates with a content server through the Internet;
a content reproducing unit that reproduces the content data; and
an authentication request unit that requests the server to authenticate a downloading of the content data through the IP telephone unit when the internet communication unit transmits to the content server a request for downloading the content data from the content server;
wherein the server includes:
an authentication determination unit that determinates whether the downloading is authenticated when the request for authenticating the downloading is received from the content reproducing device; and
an output unit that outputs an authentication result of the authentication determination unit to the content server; and
wherein the content server includes a downloading permission unit that determines whether the downloading is permitted in accordance with the authentication result outputted from the server.

8. The content distribution system as set forth in claim 7, wherein the IP telephone unit is an SIP communication unit for conducting communications in accordance with Session Initiation Protocol.

9. The content distribution system as set forth in claim 7, wherein the server is an IP telephone server.

10. A server, comprising:
a receiving unit that receives a request for authenticating a downloading of content data stored in a content server through an IP telephone communications from a content reproducing device;
an authentication determination unit that determinates whether the downloading of the content data to the content server is authenticated when the request is received; and
an output unit that outputs an authentication result of the authentication determination unit to the content server.

11. The server as set forth in claim 10, wherein the server is an IP telephone server.

12. The server as set forth in claim 10, wherein the server is configured to connect to a plurality of the content servers; and
wherein the receiving unit receives the request for authenticating the downloading of content data stored in at least one of the content servers.

13. The server as set forth in claim 10, further comprising an IP telephone unit that conducts IP telephone communications with the reproducing device by using a predetermined protocol in accordance with identification data for identifying the reproducing device.
